(19) United States
(12) Patent Application Publication
(10) Pub. No.: US 2012/0280777 A1
(43) Pub. Date: Nov. 8, 2012

(54) EASILY INSTALLED ROTARY TRANSFORMER

(75) Inventor: Jean-Albert Paul Marc Robert, Versailles (FR)

(73) Assignee: Hispano-Suiza, Colombes (FR)

(21) Appl. No.: 13/512,405

(22) PCT Filed: Nov. 30, 2010
(86) PCT No.: PCT/EP10/68454

§ 371 Date: Jul. 19, 2012

(30) Foreign Application Priority Data
Nov. 30, 2009 (FR) 0958487

(51) Int. Cl. H01F 21/06

(52) U.S. Cl. 336/120

(57) ABSTRACT

A rotary transformer configured to be installed about a rotatably movable shaft, the rotary transformer including, an annular inner core and an annular outer core for transmitting electrical energy via electromagnetic induction between the inner core and the outer core, which are coaxially mounted such that an inner surface of the outer core is capable of rotating opposite an outer surface of the inner core, wherein the inner core consists of a plurality of inner-core disjointed portions, which are assembled together by a first attachment, and wherein the outer core consists of a plurality of outer-core disjointed portions which are assembled together by a second attachment.

### TECHNICAL FIELD OF THE INVENTION

The object of the present invention is an easily installed rotary transformer. It concerns essentially rotary transformers of the single-phase type, used to realize a transfer of electrical power between a fixed element and a moving element, typically moving rotatably, in particular within the recovery of position information by sensors intervening for the variable setting of blades and for the setting of the propeller pitch of helicopters.

The field of the invention is, generally speaking, that of rotary transformers which are used for the transmission of electrical energy via electromagnetic induction between first and second windings fixed concentrically respectively on first and second tubular parts, of ferromagnetic material, mounted coaxially such that an outer surface of one can rotate opposite an inner surface of the other.

Among the industries which can profit from the use of rotary transformers, in particular the space industries can be mentioned, for example for transmitting, in a satellite, an electrical supply current to a measurement instrument mounted on a support plate with a rotating joint, permitting it to be oriented with respect to the stars. Such rotary transformers are also used in the aeronautical industry, in particular for torque sensors, for example for uses for the setting of the propeller pitch for helicopters. Specific functions, known under the terms “de-icing of the rear rotor” and “pitch control” can, furthermore, necessitate a transfer of electrical power. For such uses, the removal of the conventional friction brush collector and its replacement by such a transformer are advantageous. Such a transformer allows the reliability of the equipment to be increased by removing the risk of a breakdown created by the wearing of the brushes.

### TECHNOLOGICAL BACKGROUND OF THE INVENTION

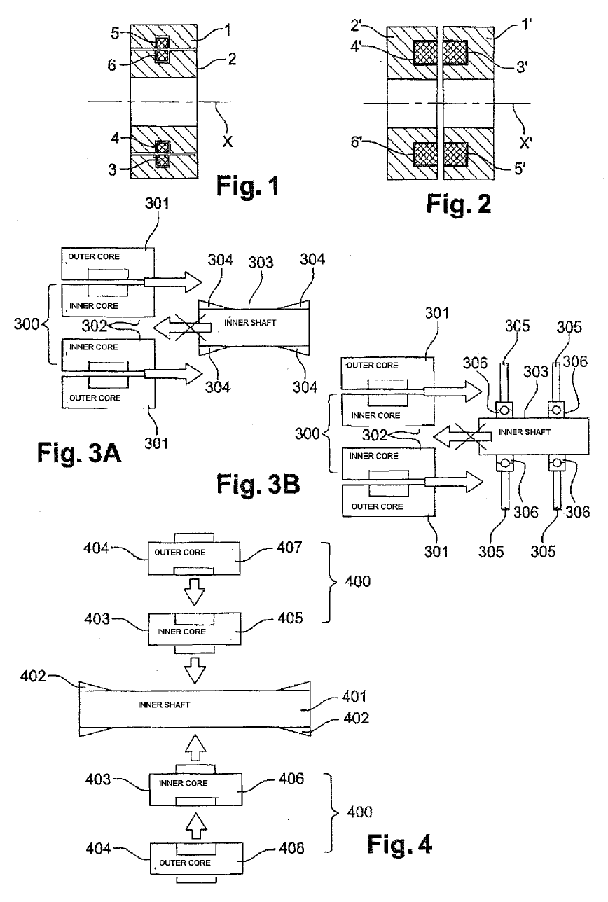

In FIGS. 1 and 2 of the attached drawings, rotary transformers of known types have been represented diagrammatically. The one represented in FIG. 1 comprises essentially two parts 1 and 2, corresponding respectively to an inner core and an outer core in the form of an annular ring, mounted concentrically such that one can rotate with respect to the other about a common axis X, the parts 1 and 2 being hollowed by annular grooves 3 and 4 respectively in which electrical windings 5 and 6 are housed respectively. The interior diameter of the part 1 is slightly greater than the exterior diameter of the part 2 such that the latter can rotate in the part 1 without physical contact therewith. Thus, radial gaps are provided, currently of a thickness in the order of 0.1 mm, on either side of the windings. These latter are wound directly on the parts 1 and 2, made from a magnetic material such as a ferrite.

In a variant, as illustrated diagrammatically in FIG. 2, a transformer is also known comprising two rings 1′ and 2′ which are rotatably movable about the same axis X′, two axial ends disposed opposite these rings being hollowed by two annular grooves 3′ and 4′ respectively, receiving windings 5′ and 6′ respectively. The gaps disposed on either side of the windings are therefore axial.

However, the known rotary transformers described above in connection with FIGS. 1 and 2 present limitations which greatly restrict their use. These limitations are illustrated in FIGS. 3-A and 3-B. In these figures, the fact that such rotary transformers cannot easily be installed—even not at all—in certain locations has been illustrated diagrammatically. In fact, all the rotary transformers, such as an existing transformer 300 represented in FIGS. 3-A and 3-B, with concentric annular outer core 301 and annular inner core 302, are realized in one piece. They must therefore be positioned by sliding about the elements, in particular of the shaft type, which they are intended to equip. Thus, they cannot, for example, be installed around a mechanical shaft 303 without dismantling of the shaft concerned when the said shaft 303 has certain characteristics. These characteristics can be of different types, such as for example flared ends 304 represented in FIG. 3-A, or else walls 305 connected to the shaft 303 by bearings 306, as represented in FIG. 3-B.

### GENERAL DESCRIPTION OF THE INVENTION

The object of the invention proposes a solution to the problems which have just been exposed. The present invention has precisely the aim of realizing a rotary transformer which is not affected by the limitations mentioned above. Generally speaking, the invention proposes essentially a rotary transformer, the topology of which permits an installation or a withdrawal of the said transformer around a shaft without a handling operation, in particular without a sliding operation of the shaft in the core zone of the transformer.

Advantageously, the rotary transformer according to the invention also allows a problem to be solved which is frequently encountered in rotary transformers of the prior art: in the existing rotary transformers, the type of material of the inner shaft can affect the characteristics of the transformer, in particular magnetizing inductance, leakage inductance, or else the efficiency characteristics. In fact, if the inner shaft is a magnetic flux conductor, an increase is observed in the reluctance of the magnetic circuit formed by the cores of the rotary transformer. In advantageous embodiments of the invention, the characteristics of the transformer are independent of the shaft concerned.

The invention therefore concerns essentially a rotary transformer intended to be installed about a rotatably movable shaft, said rotary transformer comprising, in particular, an annular inner core and an annular outer core for transmitting electrical energy via electromagnetic induction between said inner core and said outer core, which are coaxially mounted such that an inner surface of the outer core is capable of rotating opposite an outer surface of the inner core, characterized in that the inner core consists of a plurality of inner-core disjoined portions, which are assembled together by a first attachment means, and in that the outer core consists of a plurality of outer-core disjoined portions which are assembled together by a second attachment means.

As well as the main characteristics which have just been mentioned in the preceding paragraph, the rotary transformer according to the invention can present one or more complementary characteristics from the following, considered individually or according to all technical possible combinations:
the inner-core disjointed portions have identical shapes and dimensions;
the outer-core disjointed portions have identical shapes and dimensions;
each inner-core disjointed portion and each outer-core disjointed portion comprises an electrical winding;
each inner-core and/or outer-core disjointed portion has a first lateral groove and a second lateral groove in which the electrical winding of the portion concerned passes;
each inner-core and/or outer-core disjointed portion has an annular groove, present on the inner face and/or on the outer face of the portion concerned, in which the electrical winding of the portion concerned passes;
the whole of the inner-core disjoined portions and/or the whole of the outer-core disjointed portions are supplied by the same current source;
the first attachment means and/or the second attachment means consist of an encircling of armatures of the inner-core and/or outer-core disjointed portions;
the first attachment means and/or the second attachment means comprise bolts disposed at the level of armatures of the inner-core and/or outer-core disjointed portions;
two assembled inner-core disjointed portions have a first flat junction surface and in that two assembled outer-core disjointed portions have a second flat junction surface, each first flat junction surface and each second flat junction surface being radially aligned;
the inner core and the outer core are each constituted by two core disjointed portions.

The invention and its various applications will be better understood on reading the following description and on examining the figures which accompany it.

### BRIEF DESCRIPTION OF THE FIGURES

These are only presented as an indication and as being in no way restrictive with regard to the invention. The figures show:

in FIG. 1, already described, a first example of a rotary transformer of known type;

in FIG. 2, also already described, a second example of a rotary transformer of known type;

in FIGS. 3-A and 3-B, diagrammatic representations of inner shafts around which the rotary transformers of known type cannot be easily installed;

in FIG. 4, a diagrammatic representation of an installation operation of a rotary transformer according to the invention around a shaft;

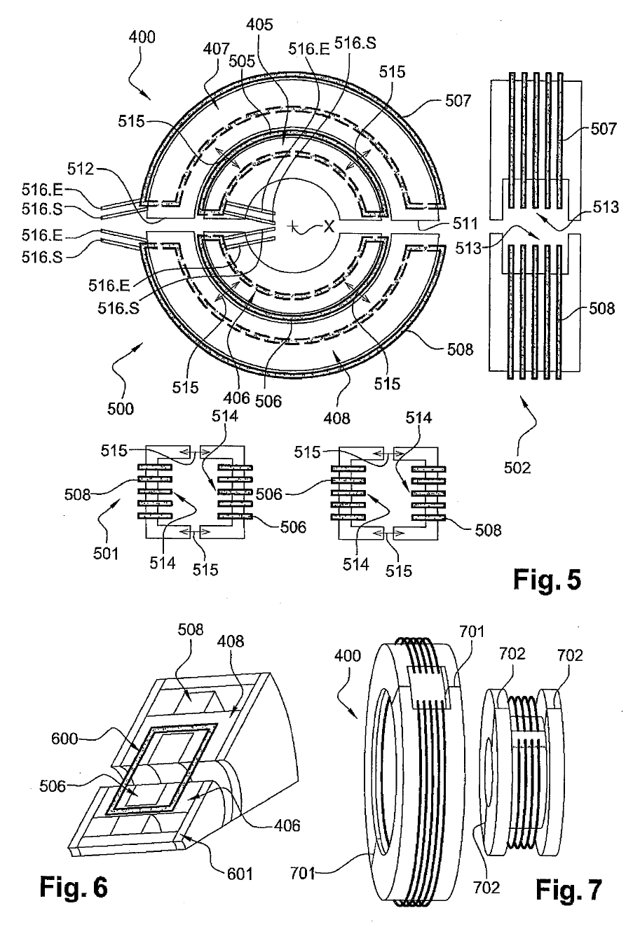

in FIG. 5, a detailed representation of a first example embodiment of a rotary transformer according to the invention;

in FIG. 6, a detailed representation, in section, of the example embodiment of a rotary transformer of FIG. 5;

in FIG. 7, a diagrammatic representation, in perspective, of the first example embodiment of the rotary transformer according to the invention;

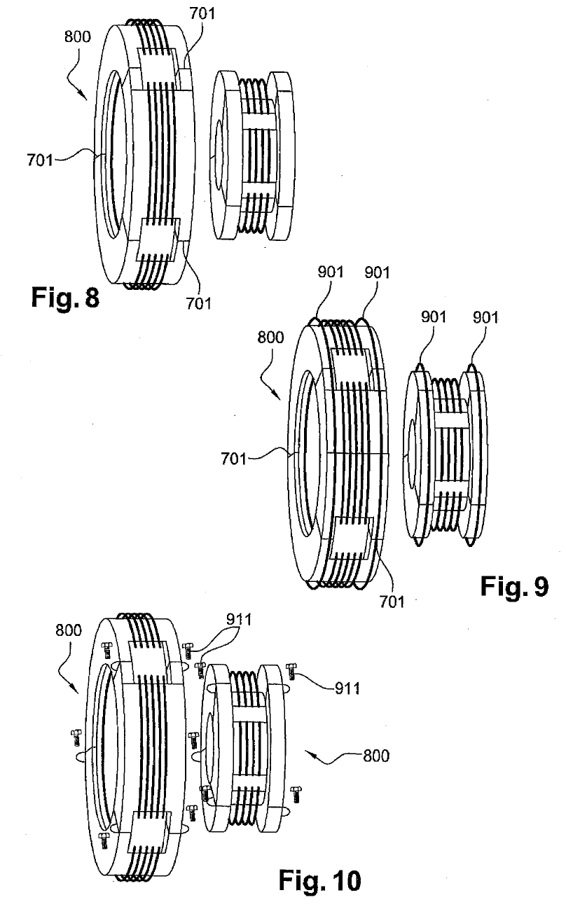

in FIG. 8, a diagrammatic representation, in perspective, of a second example embodiment of the rotary transformer according to the invention;

in FIG. 9, a diagrammatic representation, in perspective, of the second example embodiment of the rotary transformer according to the invention with a first possibility for assembly,

in FIG. 10, a diagrammatic representation, in perspective, of the second example embodiment of the rotary transformer according to the invention with a second possibility for assembly.

### DETAILED DESCRIPTION OF THE PREFERRED EMBODIMENTS OF THE INVENTION

Unless specified otherwise, the same element appearing in different figures has one single reference number.

The general principle of the rotary transformers according to the invention is illustrated in FIG. 4. In this figure, a shaft 401 has been shown, at the ends of which flares 402 are present, which make the installation of a rotary transformer of the prior art impossible by a sliding operation along the shaft 401. To make possible the installation of rotary transformers around such shafts, it is proposed, in the invention, to realize a rotary transformer 400 comprising an annular inner core 403 and an annular outer core 404, both constituted by several disjointed parts or portions. The expression “disjointed portion of a core” designates an element intended to contribute to the constitution of a closed annular magnetic core, by juxtaposition with other core portions.

Thus, in the example which is represented, the inner core 403 is constituted by a first half-core 405 and a second half-core 406, and the outer core 404 is constituted by a first half-core 407 and a second half-core 408. By proposing inner and outer cores composed of disjointed parts, the shaft 401 can be equipped with a rotary transformer by placing, by a directly lateral positioning, the half-cores which have just been mentioned around the shaft 401, and by assembling them with respect to one another to reconstitute an annular inner core, and an annular outer core of a rotary transformer. Each of the half-cores concerned comprises an electrical winding, the characteristics of which, and in particular the positioning, will be described in detail below.

FIG. 5 shows in greater detail the rotary transformer 400 of FIG. 4, with a front view 500, a bottom view 501 and a lateral view 502 of the said transformer 400. In particular, the different electrical windings in the rotary transformer 400 have been detailed.

As already specified, each annular (inner and outer) core constituting the rotary transformer is constituted by a plurality of ring parts. For each ring concerned, the ring parts constituting it advantageously have the same shapes and dimensions. The ring parts are thus portions of annular rings, each having a first lateral part 511 and a second lateral part 512, each lateral part of a given ring part being intended to be positioned opposite a lateral part of a following ring part, such that the assembly of the ring parts correctly positioned effectively constitutes an annular core.

In the rotary transformers according to the invention, each inner or outer core disjoined portion comprises an electrical winding wound around it. Thus, the half-cores 405, 406, 407 and 408 comprise respectively an electrical winding 505, 506, 507 and 508. In the transformers according to the invention, such as for example in that of FIGS. 4 and 5, each electrical winding is disposed about the disjointed element which is associated therewith, proceeding to a coiling realizing a plurality of passages around the said disjointed element concerned, each of the passages of the coiling concerned being contained overall in a plane perpendicular to a central axis X of the rotary transformer. Thus, the electrical winding of each part adapts itself to the curvature of the ring parts to which it is associated.

In the example which is represented, so as to facilitate the assembly of the different ring portions by limiting the overall dimensions due to the presence of the electrical windings, provision is made to arrange a groove 513, designated as lateral groove, at the level of the lateral parts of each ring part concerned. The dimension of the grooves is such that two electrical windings of two consecutive disjointed ring portions do not come into contact when the two ring elements are assembled.

Advantageously, as illustrated in FIG. 5, provision is made to realize, for each ring element, an annular groove 514, i.e. a groove which is hollowed according to the incurved part of the portion concerned, so as to pass the electrical winding. In the example which is represented, the annular grooves are grooves realized at the level of the inner faces of the ring portions constituting the inner core and the outer core. The inner face of a core portion designates the incurved face with the smallest dimension, the outer face being the face with the largest dimension. In other example embodiments, provision is made to realize annular grooves at the level of the outer faces, in place of the annular grooves of the inner faces, or as a complement to the annular grooves of the said inner faces. The realization of annular grooves essentially allows the removal of the risks of contact between the electrical windings disposed on the outer cores and on the inner cores, the increase of a gap 515 between the inner and outer cores, or the limiting of the overall dimensions of the rotary transformer.

Each electrical winding has an input end 516-E and an output end 516-F which belong to it. Advantageously, in the invention, provision is made that the electrical windings of the different portions constituting the inner core are supplied by a same first current source. In the same way, provision is made that the electrical windings of the different portions constituting the outer core are supplied by a same second current source, which may be possibly different from the first current source. By having a sole current source for each core of the transformer, an optimum stability of the characteristics of the transformer is ensured.

As illustrated in FIG. 6, which shows an angular portion of the rotary transformer of FIG. 5, with the arrangement of the electrical windings which has just been described with reference to FIG. 5, there is noted in the transformers according to the invention a circulation of magnetic flux in an inner zone 600 to the magnetic core constituted by the inner core and the outer core. The magnetic flux is thus channeled in the magnetic core, without circulation in the inner shaft around which the transformer according to the invention is disposed. The characteristics of the transformer are thus independent of the mechanical shaft, and they are little affected by a small translation of the rotary transformer according to the axis of the mechanical shaft.

FIG. 7 shows a diagrammatic representation of the rotary transformer of FIG. 5, in perspective, with an inner core removed from the outer core to better display the shape of the different elements constituting the rotary transformer.

If, in the representations of FIGS. 4 to 7, the inner and outer cores are each composed solely of two half-cores, in other example embodiments, provision is made that the inner and outer cores comprise more than two disjointed parts.

Thus, FIG. 8 shows a diagrammatic representation of a second example of a rotary transformer 800 according to the invention, with each annular core (outer and inner) constituted by three ring parts. The representation is a representation in perspective, with an inner core removed from the outer core to better display the shape of the different elements constituting the rotary transformer.

In an advantageous example embodiment of the rotary transformers according to the invention, two assembled inner-core disjointed portions have a first flat junction surface 702, two assembled outer-core disjointed portions presenting a second flat junction surface 701, each first flat junction surface 702 and each second flat junction surface 701 being radially aligned, as visible in particular in FIGS. 7 and 8.

FIG. 9 shows a first example of assembly of the different disjointed core portions; in this first example, an encircling 901 is realized at the level of armatures 601—visible in particular in FIG. 6—disposed on the core portions at the level of the lateral walls oriented according to a plane perpendicular to the axis X.

FIG. 10 shows a second example of assembly of the different disjointed core portions; in this second example, an assembly is realized by bolts 911, the said bolts 911 being disposed at the level of the armatures 601.

More generally, the inner-core disjointed portions are assembled by a first attachment means, the outer-core disjointed portions being assembled by a second attachment means, the first attachment means and the second attachment means not necessarily being identical.

1. A rotary transformer configured to be installed about a rotatably movable shaft, said rotary transformer comprising:
an annular inner core and an annular outer core 5 configured to transmit electrical energy via electromagnetic induction between said inner core and said outer core, which are coaxially mounted such that an inner surface of the outer core is capable of rotating opposite an outer surface of the inner core, wherein the inner core includes a plurality of inner-core disjointed portions, each comprising an electrical winding, which are assembled together by a first attachment, and wherein the outer core includes a plurality of outer-core disjointed portions, each comprising an electrical winding, which are assembled together by a second attachment.

2. The rotary transformer according to claim 1, wherein:
the inner-core disjointed portions have identical shapes and dimensions;
the outer-core disjointed portions have identical shapes and dimensions.

3. The rotary transformer according to claim 1, wherein each inner-core and/or outer-core disjointed portion has a first lateral groove and a second lateral groove, in which the electrical winding of the portion concerned passes.

4. The rotary transformer according to claim 1, wherein each inner-core and/or outer-core disjointed portion has an annular groove, present on the inner face and/or on the outer face of the portion concerned, in which the electrical winding of the portion concerned passes.

5. The rotary transformer according to claim 1, wherein the whole of the inner-core disjointed portions and/or the whole of the outer-core disjointed portions are supplied by the same current source.

6. The transformer according to claim 1, wherein the first attachment and/or the second attachment consist of an encircling of armatures of the inner-core and/or outer-core disjointed portions.

7. The transformer according to claim 1, wherein the first attachment and/or the second attachment comprise bolts disposed at the level of armatures of the inner-core and/or outer-core disjointed portions.

8. The rotary transformer according to claim 1, wherein two assembled inner-core disjointed portions have a first flat junction surface and wherein two assembled outer-core disjointed portions have a second flat junction surface, each first flat junction surface and each second flat junction surface being radially aligned.

9. The rotary transformer according to claim 1, wherein the inner core and the outer core are each constituted by two core disjointed portions.
